(19) United States
(12) Patent Application Publication
(10) Pub. No.: US 2017/0169469 A1
(43) Pub. Date: Jun. 15, 2017

(54) METHODS, SYSTEMS, NETWORKS, AND MEDIA FOR PREDICTING CARDHOLDER SPENDING, INCLUDING CULTURAL HERITAGE TOURIST (CHT) SPENDING

(71) Applicant: MASTERCARD INTERNATIONAL INCORPORATED, PURCHASE, NY (US)

(72) Inventors: Shen Xi Meng, Millwood, NY (US); Po Hu, Norwalk, CT (US); Qian Wang, Ridgefield, CT (US)

(73) Assignee: MASTERCARD INTERNATIONAL INCORPORATED, PURCHASE, NY (US)

(21) Appl. No.: 14/965,277

(22) Filed: Dec. 10, 2015

(51) Int. Cl. G06Q 30/02

(52) U.S. Cl. CPC G06Q 30/0255; G06Q 30/0201

(57) ABSTRACT

Method for predicting cardholder spending can include storing information regarding payment card transactions of at least one cardholder at a database. Information regarding cultural heritage locations can be stored at the database. Merchants related to cultural heritage tourism can be automatically identified based on the information stored at the database. Based on the information regarding payment card transactions of each cardholder at the identified merchants, whether each cardholder is in a cultural heritage tourist target category can be automatically detected. Whether each cardholder is interested in additional cultural heritage tourism transactions can be predicted using a predictive model based on the information regarding payment card transactions, the information regarding cultural heritage locations, and the detected cultural heritage tourist target category. Systems, networks, and media are also disclosed.

### BACKGROUND

The disclosed subject matter relates to methods, systems, networks, and media for predicting cardholder spending, including predicting whether a cardholder is interested in cultural heritage tourism spending.

Cultural heritage tourism is a fast growing segment in the tourism industry in recent years. Therefore, “culture” can be a marketing tool to attract those travelers with special interests in cultures, heritages, and arts. For example, cultural heritage locations can range from large, well-known, or world-renowned locations to smaller attractions that underpin local identities.

Techniques for maintaining records of cardholder spending are known. These existing techniques can include an account statement having information related to payment card transactions of the cardholder such as the amount spent and the identification of the merchant. However, it can be difficult to determine the reason for such spending, for example, whether such spending is related to a location such as a cultural heritage tourism location. Moreover, it can be difficult to predict whether a cardholder is interested in a particular type of future spending, for example, additional cultural heritage tourism transactions.

Accordingly, there exists a need for improved techniques for predicting cardholder spending, including predicting whether a cardholder is interested in cultural heritage tourism spending.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for predicting cardholder spending is disclosed. The method can include storing information regarding payment card transactions of at least one cardholder at a database. Information regarding cultural heritage locations can be stored at the database. Merchants related to cultural heritage tourism can be automatically identified based on the information stored at the database. Based on the information regarding payment card transactions of each cardholder at the identified merchants, whether each cardholder is in a cultural heritage tourist target category can be automatically detected. Whether each cardholder is interested in additional cultural heritage tourism transactions can be predicted using a predictive model based on the information regarding payment card transactions, the information regarding cultural heritage locations, and the detected cultural heritage tourist target category.

For purpose of illustration and not limitation, the database can be a relational database. Additionally, the information regarding payment card transactions can be automatically captured from a payment network. For example, the information regarding payment card transactions can be received at a server coupled to the payment network, and the information can be sent from the server to the database.

As embodied herein, the information regarding payment card transactions can include least one of account identification information, location information, and transaction information. For example, location information can include a location of each transaction. Additionally, transaction information can include at least one of merchant identification information, amount of transaction, and destination information. Merchant identification information can include a type of merchant, e.g., museum, historical site, cultural location, hotel, or the like.

For example and not limitation, at least one external source of information regarding cultural heritage locations can be identified. The information regarding cultural heritage locations can be provided from the external source to the database. Additionally, the information can be reformatted to be readable by the database. For example, the information from the external source can be automatically extracting, and the extracted information can be stored in a format readable by the database. For purpose of illustration and not limitation, the automatically identifying, the automatically detecting, and the predicting can be performed at a server separate from the database.

As embodied herein, the information regarding cultural heritage locations can include at least one of geographic information, historical information, weather information, or seasonal information. Additionally or alternatively, the information regarding cultural heritage locations can include at least one of past cultural heritage locations and future cultural heritage locations.

For illustration and not limitation, whether each transaction is a travel transaction can be determined. For example, information regarding payment card transactions can include a location of each transaction, and whether the location of each transaction is at least a selected distance from an address of the at least one cardholder can be determined. Additionally or alternatively, information regarding payment card transactions can include merchant identification information, and merchants associated with at least one travel transaction can be identified. For example, a list of merchants identified as associated with at least one travel transaction can be compiled. A set of dimensions associated with each merchant identified as associated with at least one travel transaction can be selected, e.g., time in relation to a cultural heritage location, location in relation to a cultural heritage location, or the like. At least one of unsupervised learning or cluster analysis can be performed based on the set of dimensions. Based on the unsupervised learning or cluster analysis, whether each merchant is related to cultural heritage tourism can be identified.

As embodied herein, automatically detecting whether each cardholder is in a cultural heritage tourist target category can include calculating a proportion of the payment card transactions of each cardholder that are at merchants identified as related to cultural heritage tourism. Whether the proportion is greater than a threshold can be determined. Additionally, a timeframe can be selected, and a proportion of the payment card transactions of each cardholder in the timeframe that are at merchants identified as related to cultural heritage tourism can be calculated. Whether the proportion in the timeframe is greater than the threshold can be determined.

Additionally or alternatively, a proportion of the payment card transactions of each cardholder that are in a subcategory can be calculated. Whether the proportion of payment card transactions of each cardholder that are in the subcategory is greater than a threshold can be determined. For example and not limitation, the target subcategory can be one of a demographic subcategory, an era subcategory, a distance category, or a spending category.

As embodied herein, predicting whether each cardholder is interested in additional cultural heritage tourism transactions can include defining a timeframe for the predictive model. A modeling sample can be defined, and the predictive model can be developed based on the information stored at the database to predict the likelihood that each cardholder is interested in the additional cultural heritage tourism transactions. Additionally or alternatively, the performance of the predictive model can be validated, e.g., with out-of-time data.

For purpose of illustration and not limitation, additional information regarding payment card transactions of the at least one cardholder can be obtained. Whether each cardholder is interested in future cultural heritage tourism transactions can be predicted using the predictive model and the additional information regarding payment card transactions.

As embodied herein, each cardholder predicted to be interested in additional cultural heritage tourism transactions can be contacted. For example and not limitation, each customer can be offered at least one additional cultural heritage tourism transaction. Additionally or alternatively, each customer can be offered a reward based on future cultural heritage tourism transactions.

In accordance with another aspect of the disclosed subject matter, a system for predicting cardholder spending is disclosed. The system can include at least one database. The database can store information regarding payment card transactions of at least one cardholder and store information regarding cultural heritage locations at the database. Additionally, at least one first server can be coupled to the database. The first server can automatically identify merchants related to cultural heritage tourism based on the information stored at the database, automatically detect whether each cardholder is in a cultural heritage tourist target category based on the information regarding payment card transactions of each cardholder at the identified merchants, and predict whether each cardholder is interested in additional cultural heritage tourism transactions using a predictive model based on the information regarding payment card transactions, the information regarding cultural heritage locations, and the detected cultural heritage tourist target category.

For purpose of illustration and not limitation, the database can be a relational database. Additionally, the system can further include at least one payment network server connected to a payment network and configured to automatically capture the information regarding payment card transactions from the payment network and send the information regarding payment card transactions from the server to the database.

Additionally or alternatively, the system can further include at least one second server. The second server can receive the information regarding cultural heritage locations from at least one external source and provide the information regarding cultural heritage locations from the at least one external source to the database.

For purpose of illustration and not limitation, the first server can automatically identify merchants related to cultural heritage tourism using at least one of unsupervised learning or cluster analysis. Additionally, the first server can automatically detect whether each cardholder is in a cultural heritage tourist target subcategory.

As embodied herein, the payment network server can obtain additional information regarding payment card transactions of the at least one cardholder, and the first server can further predict whether each cardholder is interested in future cultural heritage tourism transactions using the predictive model and the additional information regarding payment card transactions. Additionally or alternatively, the first server can contact each cardholder predicted to be interested in additional cultural heritage tourism transactions.

In accordance with another aspect of the disclosed subject matter, a payment network for predicting cardholder spending is disclosed. The payment network can include a plurality of merchants connected to at least one electronic payment network, at least one acquirer connected to the at least one electronic network, each merchant in communication with at least one of the at least one acquirer via the at least one payment network, and at least one issuer connected to the at least one electronic network, each acquirer in communication with at least one of the at least one issuer via the at least one payment network. At least one payment network server can be connected to the at least one electronic network and can automatically capture the information regarding payment card transactions from the payment network. At least one database can be connected to the at least one payment network server. The database can receive the information regarding payment card transactions from the server to the database, store information regarding payment card transactions of at least one cardholder, and store information regarding cultural heritage locations at the database. At least one first server can be coupled to the at least one database. The first server can automatically identify merchants related to cultural heritage tourism based on the information stored at the database, automatically detect whether each cardholder is in a cultural heritage tourist target category based on the information regarding payment card transactions of each cardholder at the identified merchants, and predict whether each cardholder is interested in additional cultural heritage tourism transactions using a predictive model based on the information regarding payment card transactions, the information regarding cultural heritage locations, and the detected cultural heritage tourist target category.

For example and not limitation, the database is a relational database. Additionally or alternatively, the payment network can further include at least one second server. The second server can receive the information regarding cultural heritage locations from at least one external source, and provide the information regarding cultural heritage locations from the at least one external source to the database.

For purpose of illustration and not limitation, the first server can automatically identify merchants related to cultural heritage tourism using at least one of unsupervised learning or cluster analysis. Additionally or alternatively, the first server can automatically detect whether each cardholder is in a cultural heritage tourist target subcategory.

As embodied herein, the at least one payment network server further can obtain additional information regarding payment card transactions of the at least one cardholder, and the at least one first server further can predict whether each cardholder is interested in future cultural heritage tourism transactions using the predictive model and the additional information regarding payment card transactions. Additionally or alternatively, the at least one first server can contact each cardholder predicted to be interested in additional cultural heritage tourism transactions.

In accordance with another aspect of the disclosed subject matter, a non-transitory computer readable medium is disclosed. The non-transitory computer readable medium can include an executable set of instructions to direct a processor to store information regarding payment card transactions of at least one cardholder at a database and store information regarding cultural heritage locations at the database. Merchants related to cultural heritage tourism can be automatically identified based on the information stored at the database. Whether each cardholder is in a cultural heritage tourist target category can be automatically detected based on the information regarding payment card transactions of each cardholder at the identified merchants. Whether each cardholder is interested in additional cultural heritage tourism transactions can be predicted using a predictive model based on the information regarding payment card transactions, the information regarding cultural heritage locations, and the detected cultural heritage tourist target category.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a block diagram illustrating a representative system according to an illustrative embodiment of the disclosed subject matter.

FIG. 3 is a flow chart illustrating a representative method implemented according to an illustrative embodiment of the disclosed subject matter.

FIG. 4 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for predicting cardholder spending. The disclosed subject matter is particularly suited for predicting whether a cardholder is interested in a target category of spending, for example, cultural heritage tourism spending. For purpose of illustration and not limitation, a traveler who is consistently attracted to different cultural-, heritage-, and art-related destinations can be identified as interested in cultural heritage tourism (CHT).

In accordance with the disclosed subject matter herein, a method for predicting cardholder spending is disclosed. The method can include storing information regarding payment card transactions of at least one cardholder at a database. Information regarding cultural heritage locations can be stored at the database. Merchants related to cultural heritage tourism can be automatically identified based on the information stored at the database. Based on the information regarding payment card transactions of each cardholder at the identified merchants, whether each cardholder is in a cultural heritage tourist target category can be automatically detected. Whether each cardholder is interested in additional cultural heritage tourism transactions can be predicted using a predictive model based on the information regarding payment card transactions, the information regarding cultural heritage locations, and the detected cultural heritage tourist target category.

In accordance with another aspect of the disclosed subject matter, a system for predicting cardholder spending is disclosed. The system can include at least one database. The database can store information regarding payment card transactions of at least one cardholder and store information regarding cultural heritage locations at the database. Additionally, at least one first server can be coupled to the database. The first server can automatically identify merchants related to cultural heritage tourism based on the information stored at the database, automatically detect whether each cardholder is in a cultural heritage tourist target category based on the information regarding payment card transactions of each cardholder at the identified merchants, and predict whether each cardholder is interested in additional cultural heritage tourism transactions using a predictive model based on the information regarding payment card transactions, the information regarding cultural heritage locations, and the detected cultural heritage tourist target category.

In accordance with another aspect of the disclosed subject matter, a payment network for predicting cardholder spending is disclosed. The payment network can include a plurality of merchants connected to at least one electronic payment network, at least one acquirer connected to the at least one electronic network, each merchant in communication with at least one of the at least one acquirer via the at least one payment network, and at least one issuer connected to the at least one electronic network, each acquirer in communication with at least one of the at least one issuer via the at least one payment network. At least one payment network server can be connected to the at least one electronic network and can automatically capture the information regarding payment card transactions from the payment network. At least one database can be connected to the at least one payment network server. The database can receive the information regarding payment card transactions from the server to the database, store information regarding payment card transactions of at least one cardholder, and store information regarding cultural heritage locations at the database. At least one first server can be coupled to the at least one database. The first server can automatically identify merchants related to cultural heritage tourism based on the information stored at the database, automatically detect whether each cardholder is in a cultural heritage tourist target category based on the information regarding payment card transactions of each cardholder at the identified merchants, and predict whether each cardholder is interested in additional cultural heritage tourism transactions using a predictive model based on the information regarding payment card transactions, the information regarding cultural heritage locations, and the detected cultural heritage tourist target category.

In accordance with another aspect of the disclosed subject matter, a non-transitory computer readable medium is disclosed. The non-transitory computer readable medium can include an executable set of instructions to direct a processor to store information regarding payment card transactions of at least one cardholder at a database and store information regarding cultural heritage locations at the database. Merchants related to cultural heritage tourism can be automatically identified based on the information stored at the database. Whether each cardholder is in a cultural heritage tourist target category can be automatically detected based on the information regarding payment card transactions of each cardholder at the identified merchants. Whether each cardholder is interested in additional cultural heritage tourism transactions can be predicted using a predictive model based on the information regarding payment card transactions, the information regarding cultural heritage locations, and the detected cultural heritage tourist target category.

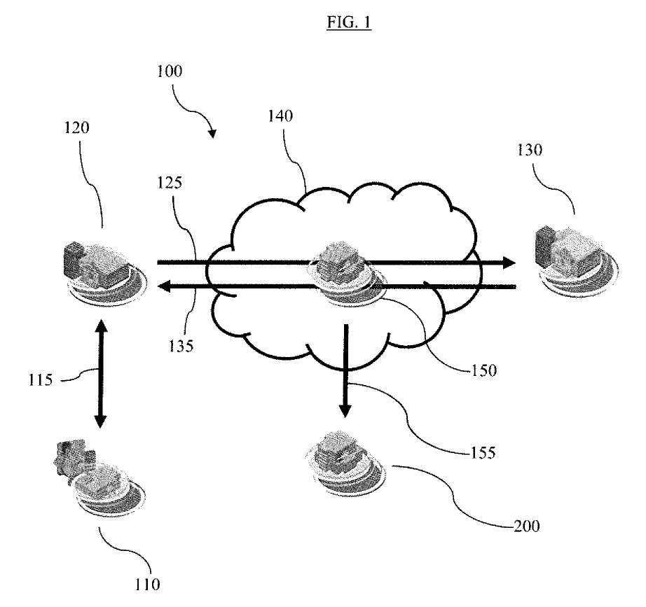

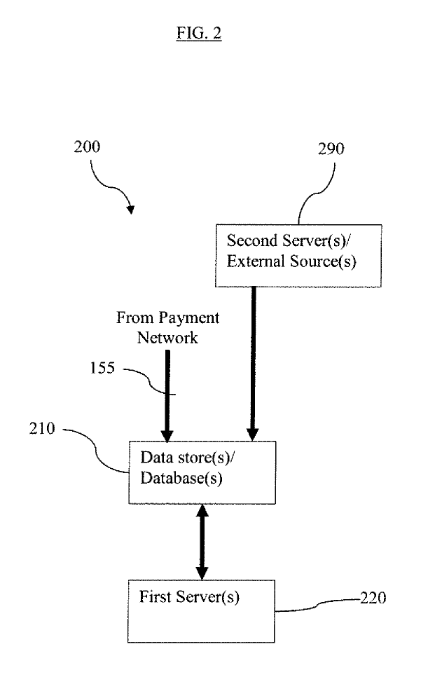

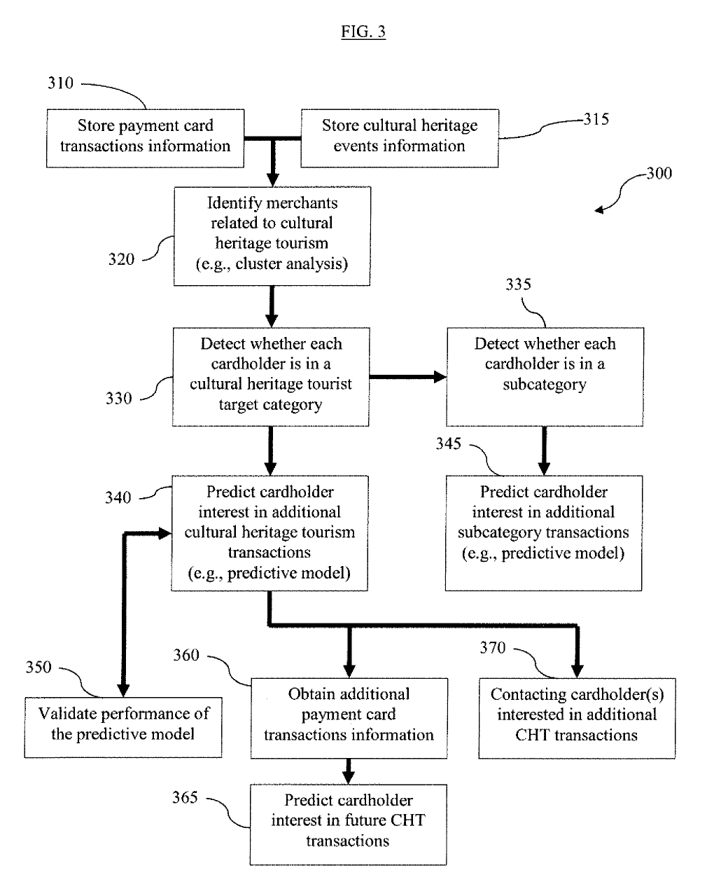

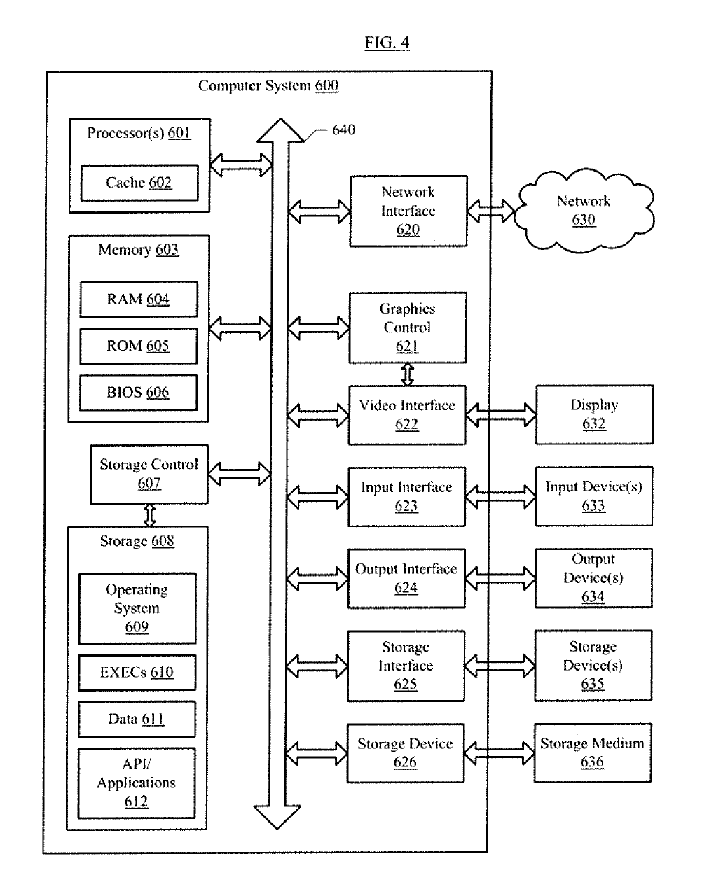

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment networks for predicting cardholder spending in accordance with the disclosed subject matter is shown in FIG. 1. An exemplary embodiment of a system for predicting cardholder spending in accordance with the disclosed subject matter is shown in FIG. 2. FIG. 3 shows an exemplary embodiment of a method for predicting cardholder spending in accordance with the disclosed subject matter. An exemplary embodiment of a computer system for use with the disclosed subject matter is shown in FIG. 4. While the present disclosed subject matter is described with respect to using methods, systems, networks, and media for predicting cardholder spending related to cultural heritage tourism, one skilled in the art will recognize that the disclosed subject matter is not limited to the illustrative embodiments. For example, the methods, systems, networks, and media for predicting cardholder spending can be used with a wide variety of settings, such as cardholder spending related to other types of tourism, other types of products, or any other suitable setting for predicting cardholder spending.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the MasterCard® payment card system interchange network. MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the payment network 100 for predicting cardholder spending can include at least one merchant 110 connected to at least one electronic payment network 140, either directly or through an acquirer 120 via connection 115. At least one acquirer 140 can be connected to the electronic network 140, each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder, who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, or contactlessly from a near-field communication device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account identification information, location information, and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the information regarding payment card transactions from the electronic payment network 140. Additionally, the payment network server can be connected to a system 200 for predicting cardholder spending either by the electronic payment network 140 or a separate connection 155. As embodied herein, the payment network server 150 can be configured to only capture the information regarding payment card transactions with the permission of the cardholder. Additionally, the payment network server 150 can be configured to only capture the information regarding payment card transactions can be in accordance with applicable data privacy laws.

FIG. 2 depicts a block diagram illustrating a representative system 200 for predicting cardholder spending according to an illustrative embodiment of the disclosed subject matter. The exemplary system 200 can include at least one data store or database 210. The data store or database 210 can be any suitable computer readable medium for storing data. For example and not limitation, the data store or database 210 can be a relational database. The database 210 can store information regarding payment card transactions of at least one cardholder and store information regarding cultural heritage locations, as discussed herein. As embodied herein, database 210 can be configured to only store the information regarding payment card transactions with the permission of the cardholder. Additionally, the database 210 can be configured to only store the information regarding payment card transactions can be in accordance with applicable data privacy laws.

Additionally, at least one first server 220 can be coupled to the at least one data store 210. The first server 220 can automatically identify merchants 110 related to cultural heritage tourism based on the information stored at the database, as discussed herein. The first server 220 also can automatically detect whether each cardholder is in a cultural heritage tourist target category based on the information regarding payment card transactions of each cardholder at the identified merchants 110, as discussed herein. Further, the first server 220 can predict whether each cardholder is interested in additional cultural heritage tourism transactions using a predictive model based on the information regarding payment card transactions, the information regarding cultural heritage locations, and the detected cultural heritage tourist target category, as discussed herein.

As embodied herein, at least one payment network server 150 can be connected to the electronic payment network 140. The payment network server 150 and can automatically capture the information regarding payment card transactions from the payment network and send the information regarding payment card transactions to the database 210.

For purpose of illustration and not limitation, at least one second server 290 can be connected to the database 210 and/or the first server 220. Alternatively, the functionality of the first server 220 and the second server 290 can be implemented on a single server. As embodied herein, the second server 290 can receive the information regarding cultural heritage locations from at least one external source. Information regarding cultural heritage locations can include any suitable information related to such locations, including without limitation, geographic information, historical information, weather information, or seasonal information. Additionally, the external source can be any suitable source of information related cultural heritage locations, such as a website, database, tour book, or the like. For example and not limitation, suitable external sources can include the following, each of which is incorporated by reference herein in its entirety: World Heritage List, United Nations Educational, Scientific, and Cultural Organization (2015), http://whc.unesco.org/en/list/; Best History & Culture Vacations—Anywhere, Trip Advisor (2015), http://www.tripadvisor.com/Inspiration-g1-c3-World.html; 10 oldest Ancient civilizations ever existed, AncientHistoryLists (2015), http://www.ancienthistorylists.com/ancient-civilizations/10-oldest-ancient-civilizations-ever-existed/; List of World Heritage Sites in China, Wikipedia (Oct. 29, 2015), https://en.wikipedia.org/wiki/List_of_World_Heritage_Sites_in_China; National and Local Weather Forecast, Hurricane, Radar, and Report, The Weather Channel (2015), http://www.weather.com/. The second server 290 can provide the information regarding cultural heritage locations to the database 210.

For purpose of illustration and not limitation, the first server 220 can automatically identify merchants related to cultural heritage tourism using at least one of unsupervised learning or cluster analysis, as discussed herein. Additionally or alternatively, the first server 220 can automatically detect whether each cardholder is in a cultural heritage tourist target subcategory, as discussed herein.

Additionally, after the predictive model for predicting cardholder interest in cultural heritage tourism is developed at the first server 220, as discussed herein, the payment network server 150 can obtain additional information regarding payment card transactions of the at least one cardholder. For example, the payment network server can obtain the additional information online in real-time. The first server 220 can predict whether each cardholder is interested in future cultural heritage tourism transactions, for example, in real time, using the predictive model and the additional information.

As discussed herein, the first server 220 can contact each cardholder predicted to be interested in additional cultural heritage tourism transactions. Additionally or alternatively, the first server 220 can be used to provide contact information of each cardholder predicted to be interested in additional cultural heritage tourism transactions to other entities, as discussed herein.

FIG. 3 is a flow chart illustrating a representative method 300 implemented according to an illustrative embodiment of the disclosed subject matter. The exemplary network 100 of FIG. 1 and system 200 of FIG. 2, for purpose of illustration and not limitation, are discussed with reference to the exemplary method of FIG. 3.

As embodied herein, at 310, information regarding payment card transactions of at least one cardholder can be stored at a database 210, as discussed herein. Additionally, at 315, information regarding cultural heritage can be stored locations at the database 210, as discussed herein.

At 320, at least one first server 220 can automatically identify merchants related to cultural heritage tourism based on the information stored at the database 210, as further discussed below. The first server 220 can also automatically detect whether each cardholder is in a cultural heritage tourist target category based on the information regarding payment card transactions of each cardholder at the identified merchants 110, as further discussed below. The first server 220 can also predict whether each cardholder is interested in additional cultural heritage tourism transactions using a predictive model based on the information regarding payment card transactions, the information regarding cultural heritage locations, and the detected cultural heritage tourist target category, as further discussed below.

As embodied herein, storing information regarding payment card transactions (310) can include automatically capturing the information regarding payment card transactions from a payment network 140. For example and not limitation, automatically capturing the information regarding payment card transactions can include receiving the information regarding payment card transactions at a payment network server 150 coupled to the payment network 140 and sending the information from the payment network server 150 to the database 210, as discussed herein.

For purpose of illustration and not limitation, the information regarding payment card transactions can include at least one of account identification information, location information, and transaction information, as discussed herein. For example, location information can include a location of each transaction. Additionally or alternatively, transaction information can include at least one of merchant identification information, amount of transaction, and destination information. For example and not limitation, destination information can include the destination of a ticket purchased with a travel company or carrier such as an airline, bus, or cruise ticket. Additionally or alternatively, destination information can includes the CHT location or event to which the transaction is related, as discussed herein. For purpose of illustration and not limitation, merchant identification information can include any suitable information such as an identification number or code and/or a type of merchant. For example, a type of merchant can include any suitable type, including a museum, a historical site, a cultural location vendor, a hotel, or the like.

As embodied herein, storing information regarding cultural heritage locations (315) can include identifying at least one external source of information regarding cultural heritage locations, as discussed herein. The information regarding cultural heritage locations can be provided from the at least one external source to the database 210, for example, by a second server 290 or an external server. Additionally, the information regarding cultural heritage locations can be reformatted to be readable by the database 210. Additionally or alternatively, the information can be automatically extracted from the external source, and the extracted information can be stored in a format readable by the database 210. As discussed herein, the information regarding cultural heritage locations can include at least one of geographic information, historical information, weather information, or seasonal information. Additionally or alternatively, the information regarding cultural heritage locations can include at least one of past cultural heritage locations and future cultural heritage locations.

For purpose of illustration and not limitation, automatically identifying merchants 110 related to cultural heritage tourism (320) can include determining whether each transaction is a travel transaction. For example, payment card transaction information can include a location of each transaction, and the server 220 can determine whether the location of each transaction is at least a selected distance from an address of the cardholder. The distance can selected to be any suitable distance, for example, a distance selected to correspond to a significant amount of travel time. For illustration and not limitation, the distance can be at least 200 miles. Additionally or alternatively, location information can include whether the transaction is across a state or national border from the cardholder's home, the city or town of the transaction (e.g., big city or small town), and or the like, and a transaction can be determined to be a travel transaction based on any of these factors or a combination of these factors.

Additionally, payment card transaction information can include merchant identification information, as discussed herein. Merchants 110 associated with at least one travel transaction can be identified. For purpose of illustration and not limitation, a list of merchants 110 identified as associated with at least one travel transaction can be compiled. A set of dimensions associated with each merchant identified as associated with at least one travel transaction can be selected. For example and not limitation, a multi-dimensional index can be created, and the dimensions can include any suitable dimensions relating the merchant to a cultural heritage location can be selected, including but not limited to proximity in time to the location, proximity in location to the location, or the like. At least one of unsupervised learning or cluster analysis can be performed based on the set of dimensions, as discussed herein. Based on the unsupervised learning or cluster analysis, the server 220 can identify whether each merchant 110 is related to cultural heritage tourism.

For purpose of illustration and not limitation, Table 1 shows exemplary information regarding hypothetical merchants related to two CHT locations, A and B. For example, at least one dimension of the set of dimensions can be distance from the CHT location. Distance can be determined based on any suitable information, for example the relative location of each merchant 110 to the CHT location. The location can be expressed in terms of any suitable metric such as geographic latitude and longitude, zip code, or the like. As demonstrated in the table, Hypothetical merchants 1-7 are all within a reasonable distance (e.g., 2 miles) of hypothetical CHT location A, whereas hypothetical merchants 11-14 are all within a reasonable distance of hypothetical CHT location B, and hypothetical merchants 8-10 are not included in the table because they are not within a reasonable distance of either hypothetical CHT location A or hypothetical CHT location B.

TABLE 1
Hypothetical CHT Locations and Merchants

| | | Distance from CHT Location to |
|---|---|---|
| CHT Location | Merchant ID | Merchant |
| A | 1 | 1.2 |
| A | 2 | 0.3 |
| A | 3 | 0.5 |
| A | 4 | 2 |
| A | 5 | 1.1 |
| A | 6 | 2 |
| A | 7 | 1.2 |
| B | 11 | 0.2 |
| B | 12 | 0.2 |
| B | 13 | 0.3 |
| B | 14 | 0.3 |

For example and not limitation, Table 2 shows exemplary information regarding hypothetical customer C1's travel transactions at select hypothetical merchants from Table 1. For example, the transactions are identified as travel transaction as discussed herein, e.g., the location is greater than a given distance from C1's home address. C1 completed travel transactions with hypothetical merchants 2, 3, and 7 associated with hypothetical CHT location A, travel transactions with hypothetical merchants 11, 12, and 13 from hypothetical CHT location B, and one transaction with hypothetical merchant 9, which is not associated with any hypothetical CHT location. From C1's transaction information, multiple CHT locations can be linked and/or clustered together. For example, C1 visited merchants identified with CHT location A in March 2013 and CHT location B in June 2013, so C1 presents a link between CHT locations A and B. If there are many customers like customer C1, CHT locations A and B can be linked as one cluster. Moreover, transaction information from multiple cardholders can be collected, and the relative strength or score of a linked cluster of CHT locations can be computed based on the number of cardholders that visited multiple locations within the same cluster. Additionally, the cluster can be bi-directional, for example, based on which CHT location each cardholder visits first. For example and not limitation, a cluster where cardholders visit CHT location A first then CHT location B second can have a different (e.g., stronger or weaker) score or correlation than a cluster where cardholders visit CHT location B then A.

TABLE 2
Hypothetical Customer Transactions at Hypothetical Merchants

| | Merchant ID | |
|---|---|---|
| | (Travel transaction, e.g., location more | |
| Customer | than given distance from home) | date |
| C1 | 2 | Mar. 18, 2013 |
| C1 | 3 | Mar. 18, 2013 |
| C1 | 7 | Mar. 19, 2013 |
| C1 | 9 | Mar. 19, 2013 |
| C1 | 11 | Jun. 25, 2013 |
| C1 | 13 | Jun. 25, 2013 |
| C1 | 13 | Jun. 26, 2013 |
| C1 | 12 | Jun. 27, 2013 |

For purpose of illustration and not limitation, Table 3 shows exemplary information regarding hypothetical CHT locations in a hypothetical cluster and merchants related to each hypothetical location. Additionally, the groups of related merchants can be subdivided into segments or sub-segments based on type of merchant. The types of merchant can be any suitable type, as discussed herein.

TABLE 3
Hypothetical Cluster of CHT Locations and Hypothetical Merchants

| Cluster A: Asia CHT Sites | | Related Merchants in Cluster A |
|---|---|---|
| Site 1 | Imperial Palaces of the | Site1-Store-1, Site1-Store-2, . . . |
| | Ming and Qing Dynasties | |
| | in Beijing and Shenyang | |
| Site 2 | Angkor | Site2-Store-1, Site2-Store-2, . . . |
| Site 3 | Temple of Preah Vihear | Site3-Store-1, Site3-Store-2, . . . |
| Site 4 | The Great Wall | Site4-Store-1, Site4-Store-2, . . . |
| Site 5 | Summer Palace, an Imperial | Site5-Store-1, Site5-Store-2, . . . |
| | Garden in Beijing | |
| Site 6 | Buddhist Monuments | Site6-Store-1, Site6-Store-2, . . . |
| | in the Horyu-ji Area | |
| Site 7 | Other site | Site7-Store-1, Site7-Store-2, . . . |
| Site 8 | Other site | Site8-Store-1, Site8-Store-2, . . . |
| Site 9 | Other site | Site9-Store-1, Site9-Store-2, . . . |
| Site | Other site | Site10-Store-1, Site10-Store-2, . . . |
| 10 | | |

As embodied herein, automatically detecting whether each cardholder is in a cultural heritage tourist target category (330) can include the first server 220 calculating a proportion of the payment card transactions of each cardholder that are at merchants 110 identified as related to cultural heritage tourism, as described herein, and determining whether the proportion is greater than a threshold. For purpose of illustration and not limitation a timeframe can be selected, and the first server 220 can calculate a proportion of the payment card transactions of each cardholder in the timeframe that are at merchants 110 identified as related to cultural heritage tourism to determine whether the proportion in the timeframe is greater than the threshold. For example, the timeframe can be any suitable timeframe, such as a given month, the past 12 months, the past three years, a timeframe between two past dates, a selected year, or the like. If the proportion is greater than the threshold, the cardholder is in the target category (e.g., target=1). Otherwise, the cardholder is not in the target category (e.g., target=0).

Additionally, at 335, the first server 221 can determine whether each cardholder is in a subcategory. For purpose of illustration and not limitation, the first server 221 can calculate a proportion of the payment card transactions of each cardholder that are in the subcategory and determine whether the proportion of payment card transactions of each cardholder that are in the subcategory is greater than a threshold. The target subcategory can be any suitable subcategory, including but not limited to a demographic subcategory (e.g., Europe, Asia, etc.), an era subcategory (e.g., ancient heritage, modern historical events, etc.), a distance subcategory (e.g., cross border, greater than a minimum distance, etc.), a spending category (e.g., high or luxury spending, low or budget spending, etc.), or the like. For example, a subcategory can be defined based on a specific type of cultural heritage tourism location or a business requirement related to cultural heritage tourism. For illustration and not limitation, the subcategory can include a certain country, group of countries, or a geographical region or population with certain conditions such as a spending amount, an average distance of travel transaction, or spending at a certain type of cultural heritage location. For example and not limitation, the subcategory can be a population of cardholders that, in the past 12 months, has made a transaction associated with one cultural heritage location that is at least 200 miles or more from those sites. Additionally or alternatively, the subcategory can be based on a CHT cluster, as described herein. For example and not limitation, the subcategory can be cardholders who spent a certain amount money in the stores related to a CHT cluster in a given time frame, e.g., “Cluster A: Asia Historical and Culture sites” in the past one year period. If the proportion is greater than the threshold, the cardholder is in the target subcategory (e.g., target=1). Otherwise, the cardholder is not in the target subcategory (e.g., target=0).

As embodied herein, predicting whether each cardholder is interested in additional cultural heritage tourism transactions (340) can include defining a timeframe for the predictive model, defining a modeling sample, and developing the predictive model. For purpose of illustration and not limitation, a timeframe can be defined as any suitable time period, as discussed herein. For example, the timeframe can be defined as the two-year period prior to a given month (e.g., October 2014), and the data from that timeframe can be used to develop the predictive model. Additionally, other data, such as the one year period following that given month can be used later for validation, as further discussed below. The modeling sample can be defined as any suitable sample from the cardholder information available, for example, all cardholders or a subset of cardholders. The predictive model can be developed based on the information stored at the database to predict the likelihood that each cardholder is interested in the additional cultural heritage tourism transactions. For example and not limitation, a statistical model can be developed based on the variables available to predict the likelihood that a cardholder is interested in additional travel to CHT locations. For purpose of illustration and not limitation, referring to Table 3 above, if a cardholder has visited one or more ancient Asian CHT locations in the cluster, a statistical model can predict the likelihood that the cardholder will visit other Asian CHT locations. Additionally, after the predictive model is developed, it can be used to predict interest in future CHT locations and/or implemented to predict the behavior of other cardholders outside of the modeling sample.

Additionally, at 350, performance of the predictive model can be validated with out-of-time data. For example and not limitation, if the predictive model is developed with data based on a given time frame (e.g., October 2012 to October 2014) the predictive model can be validated with data from a different timeframe (e.g., November 2014-November 2015) or a subset of data from the original timeframe (e.g., April 2014).

Additionally or alternatively, at 360, the payment network server 150 can obtain additional information regarding payment card transactions of the at least one cardholder. For example, the payment network server 150 can obtain the additional information in real time, and the first server 220 can make the predictions in real time. At 365, the first server 220 can predict whether each cardholder is interested in future cultural heritage tourism transactions using the predictive model and the additional information regarding payment card transactions.

For purpose of illustration and not limitation, at 370, the first server 220 can contact each cardholder predicted to be interested in additional cultural heritage tourism transactions. For example, the contact can include offering each customer at least one additional cultural heritage tourism transaction. Additionally or alternatively, the contact can include offering each customer a reward based on future cultural heritage tourism transactions.

Additionally or alternatively, contact information regarding each cardholder predicted to be interested in additional cultural heritage tourism transactions can be provided to other entities. For example and not limitation, the contact information can be provided to airline, travel, and/or cruise companies. These companies can use the information to design new or improve existent CHT programs. Additionally or alternatively, information can be provided to travel agents to help target the right consumers for their CHT programs. Additionally or alternatively, the information can be provided to credit card issuers to identify potential new card members for their travel cards or to provide or supplement reward programs.

FIG. 4 is a block diagram illustrating further details of a representative computer system according to an illustrative embodiment of the disclosed subject matter.

The systems and techniques discussed herein can be implemented in a computer system. As an example and not by limitation, as shown in FIG. 4, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g. a mouse), a touchscreen display, a microphone and voice control interface, or the like to capture user input coupled to the input interface 623 to provide data and/or user input to the processor 601. An exemplary output device 634 can be, for example, a display (e.g. a monitor) or speakers coupled to the output interface 624 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for predicting cardholder spending, comprising:
storing information regarding payment card transactions of at least one cardholder at a database;
storing information regarding cultural heritage locations at the database;
automatically identifying merchants related to cultural heritage tourism based on the information stored at the database;
automatically detecting whether each cardholder is in a cultural heritage tourist target category based on the information regarding payment card transactions of each cardholder at the identified merchants;
predicting whether each cardholder is interested in additional cultural heritage tourism transactions using a predictive model based on the information regarding payment card transactions, the information regarding cultural heritage locations, and the detected cultural heritage tourist target category; and
contacting each cardholder predicted to be interested in additional cultural heritage tourism transactions.

2. The method of claim 1, wherein storing information regarding payment card transactions comprises automatically capturing the information regarding payment card transactions from a payment network.

3. The method of claim 1, wherein the information regarding payment card transactions comprises at least one of account identification information, location information, and transaction information.

4. The method of claim 3, wherein transaction information comprises at least one of merchant identification information, amount of transaction, and destination information.

5. The method of claim 1, wherein storing information regarding cultural heritage locations comprises:
identifying at least one external source of information regarding cultural heritage locations; and
providing the information regarding cultural heritage locations from the at least one external source to the database.

6. The method of claim 1, wherein the information regarding cultural heritage locations comprises at least one of geographic information, historical information, weather information, seasonal information, past cultural heritage locations, and future cultural heritage locations.

7. The method of claim 1, wherein automatically identifying merchants related to cultural heritage tourism comprises determining whether each transaction is a travel transaction.

8. The method of claim 7, wherein information regarding payment card transactions comprises a location of each transaction and merchant identification information,
wherein determining whether each transaction is a travel transaction comprises determining whether the location of each transaction is at least a selected distance from an address of the at least one cardholder, and
wherein automatically identifying merchants related to cultural heritage tourism further comprises identifying merchants associated with at least one travel transaction.

9. The method of claim 8, wherein automatically identifying merchants related to cultural heritage tourism further comprises:
compiling a list of merchants identified as associated with at least one travel transaction;
selecting a set of dimensions associated with each merchant identified as associated with at least one travel transaction;
performing at least one of unsupervised learning or cluster analysis based on the set of dimensions; and
identifying, based on the unsupervised learning or cluster analysis, whether each merchant is related to cultural heritage tourism.

10. The method of claim 1, wherein automatically detecting whether each cardholder is in a cultural heritage tourist target category comprises:
calculating a proportion of the payment card transactions of each cardholder that are at merchants identified as related to cultural heritage tourism; and
determining whether the proportion is greater than a threshold.

11. The method of claim 10, further comprising:
selecting a timeframe,
wherein calculating the proportion of the payment card transactions of each cardholder that are at merchants identified as related to cultural heritage tourism comprises calculating a proportion of the payment card transactions of each cardholder in the timeframe that are at merchants identified as related to cultural heritage tourism, and
wherein determining whether the proportion is greater than the threshold comprises determining whether the proportion in the timeframe is greater than the threshold.

12. The method of claim 10, further comprising:
calculating a proportion of the payment card transactions of each cardholder that are in a subcategory; and
determining whether the proportion of the payment card transactions of each cardholder that are in the subcategory is greater than a threshold.

13. The method of claim 1, wherein predicting whether each cardholder is interested in additional cultural heritage tourism transactions comprises:
defining a timeframe for the predictive model;
defining a modeling sample; and
developing the predictive model based on the information stored at the database to predict the likelihood that each cardholder is interested in the additional cultural heritage tourism transactions.

14. The method of claim 13, wherein predicting whether each cardholder is interested in additional cultural heritage tourism transactions further comprises:
validating performance of the predictive model with out-of-time data.

15. The method of claim 1, further comprising:
obtaining additional information regarding payment card transactions of the at least one cardholder;
predicting whether each cardholder is interested in future cultural heritage tourism transactions using the predictive model and the additional information regarding payment card transactions.

16. The method of claim 1, wherein contacting each cardholder comprises at least one of:
offering each customer at least one additional cultural heritage tourism transaction, or
offering each customer a reward based on future cultural heritage tourism transactions

17. A system for predicting cardholder spending, comprising:
at least one database configured to:
store information regarding payment card transactions of at least one cardholder, and
store information regarding cultural heritage locations; and
at least one first server, coupled to the at least one database, and configured to:
automatically identify merchants related to cultural heritage tourism based on the information stored at the database;
automatically detect whether each cardholder is in a cultural heritage tourist target category based on the information regarding payment card transactions of each cardholder at the identified merchants;
predict whether each cardholder is interested in additional cultural heritage tourism transactions using a predictive model based on the information regarding payment card transactions, the information regarding cultural heritage locations, and the detected cultural heritage tourist target category; and
contact each cardholder predicted to be interested in additional cultural heritage tourism transactions.

18. The system of claim 17, further comprising:
at least one payment network server connected to a payment network and configured to automatically capture the information regarding payment card transactions from the payment network and send the information regarding payment card transactions from the server to the database.

19. The system of claim 17, further comprising at least one second server configured to:
receive the information regarding cultural heritage locations from at least one external source, and
provide the information regarding cultural heritage locations from the at least one external source to the database.

20. A payment network for predicting cardholder spending, comprising:
a plurality of merchants connected to at least one electronic payment network;
at least one acquirer connected to the at least one electronic network, each merchant in communication with at least one of the at least one acquirer via the at least one payment network;
at least one issuer connected to the at least one electronic network, each acquirer in communication with at least one of the at least one issuer via the at least one payment network;
at least one payment network server connected to the at least one electronic network and configured to automatically capture information regarding payment card transactions from the payment network;
at least one database connected to the at least one payment network server and configured to:
receive the information regarding payment card transactions from the server to the database,
store information regarding payment card transactions of at least one cardholder, and
store information regarding cultural heritage locations; and
at least one first server, coupled to the at least one database, and configured to:
automatically identify merchants related to cultural heritage tourism based on the information stored at the database;
automatically detect whether each cardholder is in a cultural heritage tourist target category based on the information regarding payment card transactions of each cardholder at the identified merchants;
predict whether each cardholder is interested in additional cultural heritage tourism transactions using a predictive model based on the information regarding payment card transactions, the information regarding cultural heritage locations, and the detected cultural heritage tourist target category; and
contact each cardholder predicted to be interested in additional cultural heritage tourism transactions.
